(19) United States
(12) Patent Application Publication
(10) Pub. No.: US 2020/0294411 A1
(43) Pub. Date: Sep. 17, 2020

(54) INFORMATION PROCESSING SYSTEM, INFORMATION PROCESSING APPARATUS, AND NON-TRANSITORY COMPUTER READABLE MEDIUM STORING PROGRAM

(71) Applicant: FUJI XEROX CO., LTD., Tokyo (JP)

(72) Inventor: Shinya NAKAMURA, Kanagawa (JP)

(73) Assignee: FUJI XEROX CO., LTD., Tokyo (JP)

(21) Appl. No.: 16/528,646

(22) Filed: Aug. 1, 2019

(30) Foreign Application Priority Data
Mar. 11, 2019 (JP) 2019-044196

(51) Int. Cl. G09B 7/02; G06K 9/00

(52) U.S. Cl. CPC G09B 7/02; G06K 2209/01; G06K 9/00442

(57) ABSTRACT

An information processing system includes an obtainment unit that obtains image information of an image on each document from plural documents each of which has page information regarding a page order of the plural documents and on which questions answered by an examinee are scored, a specification unit that specifies at least examinee information regarding the examinee, question point information regarding a question point which is a score of each question, and the page information from the obtained image information, and a creation unit that creates a list in which plural question points are arranged based on the page information for each examinee.

### CROSS-REFERENCE TO RELATED APPLICATIONS

This application is based on and claims priority under 35 USC 119 from Japanese Patent Application No. 2019-044196 filed Mar. 11, 2019.

### BACKGROUND

### (i) Technical Field

The present invention relates to an information processing system, an information processing apparatus, and a non-transitory computer readable medium storing a program.

### (ii) Related Art

For example, JP2018-195022A discloses that read data and user identification information obtained by performing text recognition processing on the read data are displayed, an input of a checking result by a user who checks the displayed read data and user identification information is received, unchecked user identification information for which the input of the checking result is received, among a user identification information group for individually identifying a plurality of predetermined users, is displayed so as to be selectable as user identification information of an unchecked correction candidate on a correction screen for correcting the user identification information.

### SUMMARY

There is a technology in which an examinee and a score filled for each document are read from a plurality of documents such as scored test sheets and a list in which at least the examinee and the score are arranged is created. In this case, for example, in the case of a test constituted by a plurality of questions, the plurality of questions may be separately prepared on a plurality of pages. In such a case, it is necessary to create a list in which a question point which is a score of each question and the examinee are arranged for each examinee. However, for example, in a case where the plurality of questions is separately prepared on the plurality of pages, there is a concern that a plurality of question points in the list is not to be displayed in a previously intended arrangement order in a case where a reading order of the pages is reversed at the time of reading or there is a document which is not capable of being read.

Aspects of non-limiting embodiments of the present disclosure relate to an information processing system, an information processing apparatus, and a non-transitory computer readable medium storing a program that a plurality of question points in a list is displayed in a previously intended order in a case where a plurality of questions is separately prepared on a plurality of pages.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including an obtainment unit that obtains image information of an image on each document from a plurality of documents each of which has page information regarding a page order of the plurality of documents and on which questions answered by an examinee are scored, a specification unit that specifies at least examinee information regarding the examinee, question point information regarding a question point which is a score of each question, and the page information from the obtained image information, and a creation unit that creates a list in which a plurality of the question points is arranged based on the page information for each examinee.

### BRIEF DESCRIPTION OF THE DRAWINGS

Exemplary embodiment(s) of the present invention will be described in detail based on the following figures, wherein:

FIG. 1 is a diagram showing an entire configuration of an information processing system of an exemplary embodiment;

FIGS. 2A and 2B are explanatory diagrams of answer sheets used in the present exemplary embodiment;

FIG. 3 is an example of a functional configuration of a learning support terminal of the present exemplary embodiment;

FIG. 4 is an operation flowchart for collecting a scoring result in the information processing system of the present exemplary embodiment;

FIGS. 5A and 5B are explanatory diagrams of score lists created by the information processing system of the present exemplary embodiment;

FIG. 6 is an explanatory diagram of a score list to which Modification Example 1 is applied;

FIG. 7 is an explanatory diagram of a score list to which Modification Example 2 is applied;

FIG. 8 is an explanatory diagram of a reading result list according to Modification Example 3;

FIGS. 9A, 9B, and 9C are score lists of Modification Example 3 created from the reading result list; and

FIG. 10 is a diagram showing a hardware configuration example of a computer.

### DETAILED DESCRIPTION

Hereinafter, an exemplary embodiment will be described in detail with reference to the drawings.

Entire Configuration of Information Processing System 1

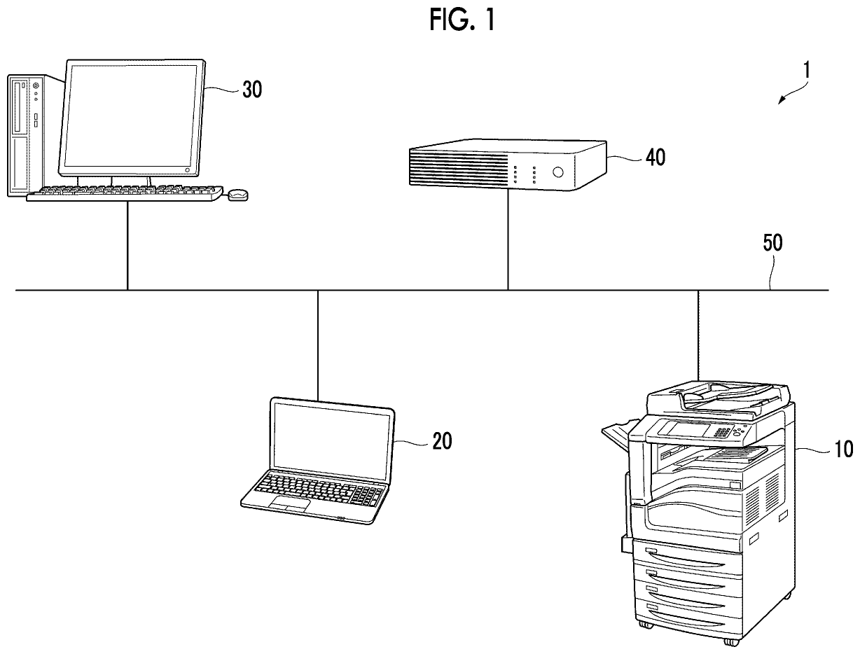

FIG. 1 is a diagram showing the entire configuration of an information processing system 1 of the present exemplary embodiment.

The information processing system 1 of the present exemplary embodiment is a system that reads an answer sheet (an example of a manuscript) of a test and collects a scoring result on the answer sheet. As shown in FIG. 1, the information processing system 1 includes an image processing apparatus 10 that performs processing related to an image, an examinee terminal 20 used by an examinee, an examiner terminal 30 used by an examiner, and a learning support terminal 40 that processes various information regarding a class. The image processing apparatus 10, the examinee terminal 20, the examiner terminal 30, and the learning support terminal 40 may perform data communication with each other via a network 50.

The image processing apparatus 10 has a scan function. That is, the image processing apparatus 10 reads image information of an image on the answer sheet. The image processing apparatus 10 generates image data indicating the read image, and performs processing on the generated image data. In the present exemplary embodiment, the image processing apparatus 10 sends the image information read from the answer sheet to the learning support terminal 40.

The image processing apparatus 10 may have, for example, a print function, a copy function, and a facsimile function, in addition to the scan function.

The examinee terminal 20 is, for example, a computer apparatus provided so as to be operated by an examinee who answers a question, such as a university student. A fixed type terminal apparatus such as a personal computer or a portable information terminal such as a tablet terminal or a smartphone may be used as the examinee terminal 20.

The examiner terminal 30 is, for example, a computer apparatus provided so as to be operated by an examiner who scores the answer sheet such as a university professor. A fixed type terminal apparatus such as a personal computer or a portable information terminal such as a tablet terminal or a smartphone may be used as the examiner terminal 30.

The learning support terminal 40 is a server apparatus that stores and manages data exchanged via the network 50. The learning support terminal 40 is, for example, an apparatus that is generally used in a system called a learning management system (LMS). In this case, the LMS is a learning management system that integrates and manages the distribution of learning materials or test scores. For example, the examinee may browse the leaning materials or scores transmitted from the learning support terminal 40 by using the examinee terminal 20. For example, the examiner may register the score including the scoring result in the learning support terminal 40 by using the examiner terminal 30, browse the score transmitted from the learning support terminal 40, or upload the learning materials to the learning support terminal 40.

The network 50 is communication means used for exchanging various information. The kind of the network 50 is not particularly limited thereto as long as the data may be transmitted or received via the network. For example, the Internet, a local area network (LAN), or a wide area network (WAN) may be used. A communication line used for data communication may be wired or wireless. The apparatuses may be connected via a plurality of networks or communication lines.

Hereinafter, an example of a utilization form of the information processing system 1 of the present exemplary embodiment will be described.

In the present exemplary embodiment, the examinee writes answers on an answer sheet for questions constituting the test by handwriting. The answer sheet on which the answers are written is scored by the examiner.

A bundle of scored answer sheets is set in the image processing apparatus 10. The image processing apparatus 10 reads an image formed on each answer sheet of the set bundle of answer sheets. The image processing apparatus 10 transmits read image information to the learning support terminal 40.

The learning support terminal 40 collects the scoring result based on the image information. Specifically, the learning support terminal 40 collects the scores (hereinafter, referred to as question points) for each question on the answer sheets. The learning support terminal 40 creates data for displaying a list on which the question points for each question for each examinee are arranged.

The examiner browses the list which is the scoring result or downloads the list by requesting the learning support terminal 40 to transmit the list via the examiner terminal 30.

Next, the answer sheet used in the present exemplary embodiment will be described in detail.

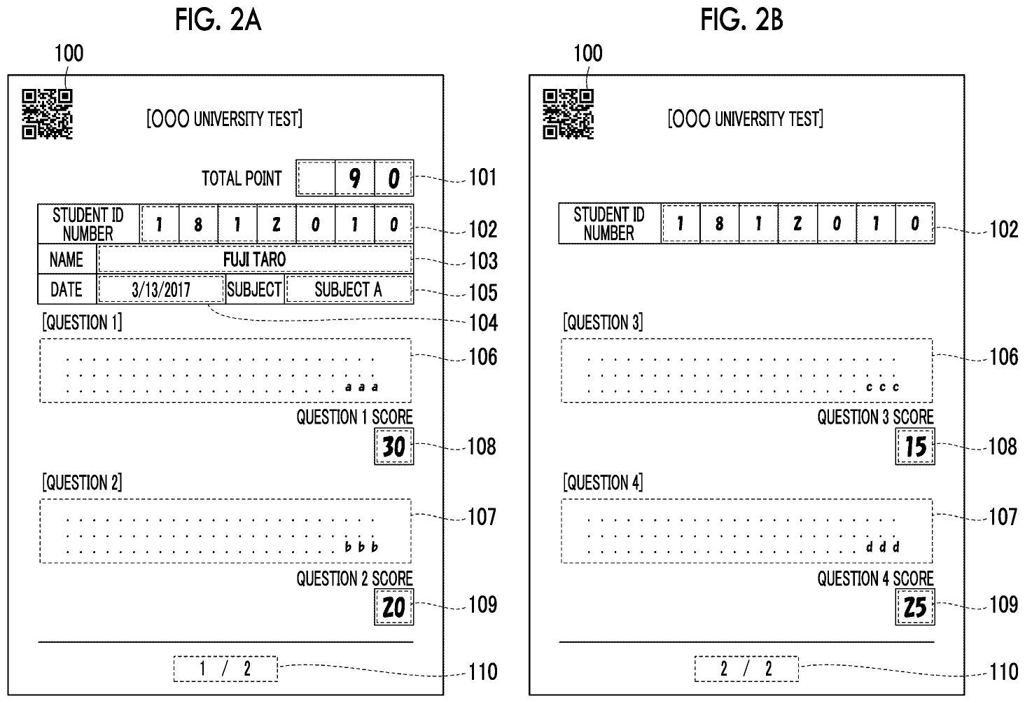

FIGS. 2A and 2B are explanatory diagrams of the answer sheets used in the present exemplary embodiment.

In the present exemplary embodiment, an example in which one test is performed by using two answer sheets is illustrated. A plurality of questions is prepared in one test, and the plurality of questions is separately described on two answer sheets. That is, in the present exemplary embodiment, the plurality of questions is separated on two pages of a first page and a second page.

In this case, for the sake of convenience in description, an example in which the questions are prepared on only one side of each of the answer sheets and reading for the answer sheets is performed on only one side thereof is illustrated in the present exemplary embodiment. Accordingly, in the description of the present exemplary embodiment, a first answer sheet is the first page, and a second answer sheet is the second page.

As shown in FIG. 2A, on an answer sheet P1 of the first page, a total point entry field 101, a number entry field 102, a name entry field 103, a date entry field 104, a subject entry field 105, a first answer entry field 106, a second answer entry field 107, a first question point entry field 108, a second question point entry field 109, and a page information entry field 110 are prepared.

As shown in FIG. 2B, on an answer sheet P2 of the second page, a number entry field 102, a first answer entry field 106, a second answer entry field 107, a first question point entry field 108, a second question point entry field 109, and a page information entry field 110 are prepared.

In the description of the present exemplary embodiment, in a case where it is not particularly distinguished whether the answer sheet is first page or the second page such as the answer sheet P1 of the first page and the answer sheet P2 of the second page, these answer sheets are collectively referred to as the “answer sheet”.

The total point entry field 101 is a field in which a total point of the question points of all the questions in one test is filled. For example, numerals are filled in the total point entry field 101 by handwriting of the examiner. In the example of the present exemplary embodiment, two question points of the answer sheet P1 of the first page and two question points of the answer sheet P2 of the second page are filled in the total point entry field 101. On the answer sheet P1 of the first page of the present exemplary embodiment, “total point” is printed as an entry field name indicating an entry field of the total point in a location adjacent to the total point entry field 101.

For example, the number entry field 102 is a field in which alphanumeric texts such as a student ID number capable of uniquely specifying the examinee are filled. For example, alphanumeric texts are filled in the number entry field 102 by handwriting of the examinee. On the answer sheet of the present exemplary embodiment, “student ID number” is printed as an entry field name indicating an entry field of the numbers in a location adjacent to the number entry field 102.

In the present exemplary embodiment, the student ID number is an example of examinee information.

The name entry field 103 is a field in which a name of the examinee is filled. For example, texts are filled in the name entry field 103 by handwriting of the examinee. On the answer sheet of the present exemplary embodiment, “name” is printed as an entry field name indicating an entry field of the name in a location adjacent to the name entry field 103.

The date entry field 104 is a field in which a date when the answer is given is filled. For example, numerals are filled in the date entry field 104 by handwriting of the examinee. On the answer sheet of the present exemplary embodiment, “date” is printed as an entry field name indicating an entry field of the date in a location adjacent to the date entry field 104.

The subject entry field 105 is a field in which a subject capable of specifying the kind of the test is filled. For example, texts capable of specifying the subject such as subject A, subject B, or final test-mathematics I are printed in the subject entry field 105. The subject entry field 105 may be filled with texts by handwriting of the examinee. On the answer sheet of the present exemplary embodiment, “subject” is printed as an entry field name indicating an entry field of the subject in a location adjacent to the subject entry field 105.

The subject filled in the subject entry field 105 is an example of kind information.

The first answer entry field 106 and the second answer entry field 107 are fields in which the answers for the questions are filled. In the present exemplary embodiment, the first answer entry field 106 is prepared on an upper side of the answer sheet, and the second answer entry field 107 is prepared on a lower side of the answer sheet. Accordingly, as an order of the first answer entry field 106 and the second answer entry field 107 on the same page of the answer sheet, the first answer entry field 106 comes first and the second answer entry field 107 comes after. For example, texts, numerals, or figures are filled in the first answer entry field 106 and the second answer entry field 107 by handwriting of the examinee. On the answer sheet of the present exemplary embodiment, “question N” (N is an integer) is printed as an entry field name indicating an entry field of the answer in a location adjacent to the first answer entry field 106 and a location adjacent to the second answer entry field 107.

In this case, in the example of the answer sheet of the present exemplary embodiment, two questions are prepared on the answer sheet P1 of the first page, and two questions are prepared on the answer sheet P2 of the second page. As shown in FIG. 2A, on the answer sheet P1 of the first page of the present exemplary embodiment, an entry field name of “question 1” is printed so as to be adjacent to the first answer entry field 106, and an entry field name of “question 2” is printed so as to be adjacent to the second answer entry field 107. As shown in FIG. 2B, on the answer sheet P2 of the second page, an entry field name of “question 3” is printed so as to be adjacent to the first answer entry field 106, and an entry field name of “question 4” is printed so as to be adjacent to the second answer entry field 107.

The first question point entry field 108 and the second question point entry field 109 are fields in which the scores for the questions are filled. As an order of the first question point entry field 108 and the second question point entry field 109 on the same page of the answer sheet, the first question point entry field 108 comes first, and the second question point entry field 109 comes after. For example, numerals are filled in the first question point entry field 108 and the second question point entry field 109 by handwriting of the examiner. On the answer sheet of the present exemplary embodiment, “question N score” (N is an integer) is printed as an entry field name indicating an entry field of the question point in a location adjacent to the first question point entry field 108 and a location adjacent to the second question point entry field 109.

As shown in FIG. 2A, on the answer sheet P1 of the first page, an entry field name of “question 1 score” is printed so as to be adjacent to the first question point entry field 108, and an entry field name of “question 2 score” is printed so as to be adjacent to the second question point entry field 109. As shown in FIG. 2B, on the answer sheet P2 of the second page of the present exemplary embodiment, an entry field name of “question 3 score” is printed so as to be adjacent to the first question point entry field 108, and an entry field name of “question 4 score” is printed so as to be adjacent to the second question point entry field 109.

In the description of the present exemplary embodiment, in a case where it is not particularly distinguished between the first answer entry field 106 and the second answer entry field 107, these entry fields are collectively referred to as the “answer entry field”. In a case where it is not particularly distinguished between the first question point entry field 108 and the second question point entry field 109, these question point entry fields are collectively referred to as the “question point entry field”.

In the present exemplary embodiment, an example in which the score filled in the question point entry field is question point information is illustrated.

The page information entry field 110 is a field in which page information including a total page number and a page number is filled. The total page number is the total number of answer sheets constituting one test that one examinee answers. In a case where one test is constituted by a plurality of pages, the page number indicates a page order which is the order of the plurality of pages. The page number is expressed from a smaller number to a larger number (that is, ascending order). In the present exemplary embodiment, only one side of the answer sheet is used as described above. Accordingly, in the present exemplary embodiment, the page order corresponds to the order of the plurality of answer sheets.

A numeral indicating the page number and a numeral indicating the total page number are filled in this order with “/ (that is, slash symbol)” interposed therebetween in the page information entry field 110.

In the example of one test of the present exemplary embodiment, “1/2” is printed in the page information entry field 110 of the answer sheet P1 of the first page, as shown in FIG. 2A. As shown in FIG. 2B, “2/2” is printed in the page information entry field 110 of the answer sheet P2 of the second page.

As shown in FIGS. 2A and 2B, for example, identification information 100 such as QR code (registered trademark) is printed in advance on the answer sheet of the present exemplary embodiment. Format information of the answer sheet is included in the identification information 100. The format information includes information of the position of each entry field of the total point entry field 101, the number entry field 102, the name entry field 103, the date entry field 104, the subject entry field 105, the first answer entry field 106, the second answer entry field 107, the first question point entry field 108, the second question point entry field 109, and the page information entry field 110 on the answer sheet.

The format information includes information of a classification of each entry field. For example, a classification of “total point” is associated with the total point entry field 101. A classification of “student ID number” is associated with the number entry field 102. A classification of “name” is associated with the name entry field 103. A classification of “date” is associated with the date entry field 104. A classification of “subject” is associated with the subject entry field 105. Two classifications of “page number” and “total page number” are associated with the page information entry field 110.

A classification of “first answer” is associated with the first answer entry field 106. A classification of “second answer” is associated with the second answer entry field 107. A classification of “first question point” is associated with the first question point entry field 108. A classification of “second question point” is associated with the second question point entry field 109.

In the information processing system 1 of the present exemplary embodiment, the order of the plurality (for example, two in the exemplary embodiment) of questions on each page is distinguished in order in a case where the format information is created, but the order of all the plurality of questions constituting one test is not distinguished in order.

That is, as the format information of the present exemplary embodiment, the classifications of “first answer” and “second answer” are associated with the first answer entry field 106 and the second answer entry field 107 prepared on the answer sheet P1 of the first page, and the classifications of “first answer” and “second answer” are associated with the first answer entry field 106 and the second answer entry field 107 prepared on the answer sheet P2 of the second page. That is, in the present exemplary embodiment, the classifications of the answer entry fields are not distinguished between the answer sheet P1 of the first page and the answer sheet P2 of the second page.

As the format information of the present exemplary embodiment, the classifications of “first question point” and “second question point” are associated with the first question point entry field 108 and the second question point entry field 109 prepared on the answer sheet P1 of the first page, and the classifications of “first question point” and “second question point” are associated with the first question point entry field 108 and the second question point entry field 109 prepared on the answer sheet P2 of the second page. That is, in the present exemplary embodiment, the classifications of the question point entry fields are not distinguished between the answer sheet P1 of the first page and the answer sheet P2 of the second page.

In this case, the reason why the order of all the plurality of questions constituting one test is not distinguished in creating the format information will be described in detail by using an example of “question point”.

In the present exemplary embodiment, in order to read “question point”, the format information is used in order to specify a reading position of the question point entry field on the answer sheet and the classification of the question entry field. A creator of the answer sheet needs to create the format information in advance according to the configuration such as the arrangement of the entry field of the question point on the answer sheet or the classification of the entry field. Accordingly, in a case where contents of the arrangement of the entry field of the question point or the classification of the entry field are different from those of the already created answer sheet, the format information is created again.

The description will be made in more detail. For example, a case where the number of questions is different for each test is considered. For example, in a case where the total number of questions is two, since two questions are prepared for each answer sheet in the example of the present exemplary embodiment, the answer sheet of one page (in the present exemplary embodiment, one answer sheet) is used. For example, in a case where the total number of questions is four, the answer sheets of two pages (in the present exemplary embodiment, two answer sheets) are used. Similarly, in a case where the total number of questions increases, the page number of answer sheets further increases.

For example, the description will be made by using an example in which question numbers are set for all the plurality of questions in one test in a question order in a case where the format information is created.

In a case where the total number of questions is two, an item name of “score of question 1” is set in an entry field of a question point of a first question on the answer sheet of the first page, and an item name of “question 2 score” is set in an entry field of a question point of a second question.

Meanwhile, in a case where the total number of questions is four, an item name of “score of question 1” is set in the entry field of the question point of the first question on the answer sheet of the first page, and an item name of “score of question 2” is set in the entry field of the question point of the second question. An item name of “score of question 3” is set in an entry field of a question point of a third question on the answer sheet of the second page, and an item name of “score of question 4” is set in an entry field of a question point of a fourth question. In this case, contents of the item names of the format information for the answer sheet of the second page are different from those of the format information for the answer sheet of the first page. Thus, in the case of the aforementioned example, it is necessary to create two different format information items for the answer sheets of two pages. In the case of the aforementioned example, the total number of questions further increases, and another format information is further created whenever the page number of answer sheets.

As described above, in a case where the format information is created while the order of all the plurality of questions constituting one test is distinguished, it is necessary to create the format information for each of the plurality of answer sheets, and there is a concern that the versatility of the answer sheet is to be remarkably reduced including the format information.

In contrast, in the present exemplary embodiment, the different format information items are created for the answer sheet P1 of the first page shown in FIG. 2A and the answer sheet P2 of the second page shown in FIG. 2B. However, in the present exemplary embodiment, for example, in a case where the number of questions further increases, the answer sheet P2 and the format information created for the answer sheet P2 may be used.

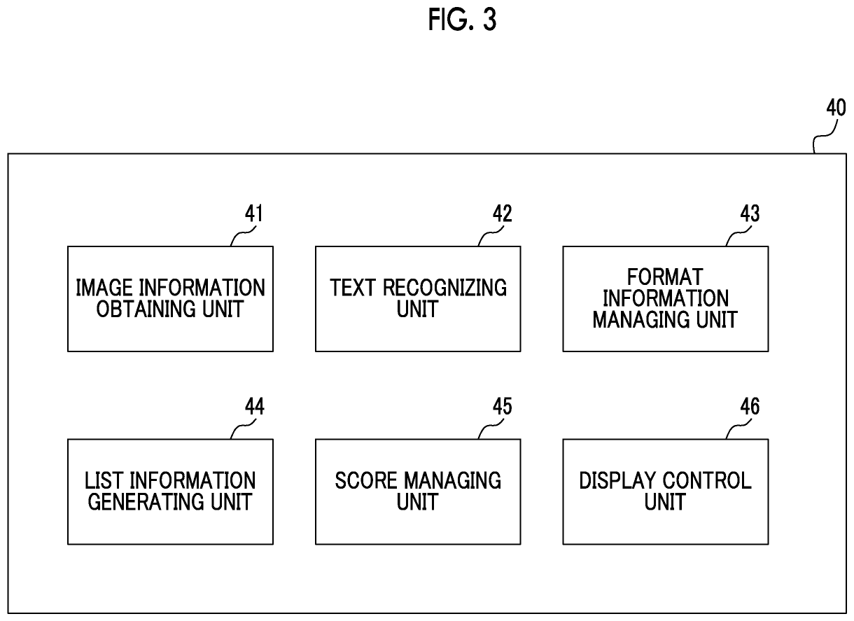

FIG. 3 is an example of a functional configuration of the learning support terminal 40 of the present exemplary embodiment.

Next, functional blocks related to the collection of the scoring result of the answer sheet of the present exemplary embodiment will be described.

As shown in FIG. 3, the learning support terminal 40 includes an image information obtaining unit 41 that obtains image information read from the answer sheet, a text recognizing unit 42 that recognizes text information from the image information, and a format information managing unit 43 that manages the formation information of the answer sheet. The learning support terminal 40 includes a list information generating unit 44 that generates list information for creating the list in which the scoring results are arranged, a score managing unit 45 that manages score information of the examinee including the scoring result, and a display control unit 46 that displays various information regarding learning support on a display screen according to a request.

In the present exemplary embodiment, the image information obtaining unit 41 is an example of an obtainment unit, and the list information generating unit 44 is an example of a specification unit and a creation unit.

The image information obtaining unit 41 obtains the image information obtained by reading the image formed on the answer sheet for the plurality of scored answer sheets set in the image processing apparatus 10 from the image processing apparatus 10.

In the present exemplary embodiment, one test is taken by a plurality of examinees. Each examinee writes the answers for the questions separately prepared on the plurality of answer sheets. The plurality of answer sheets may be bundled in the order of the questions for each examinee, the examinees may be mixed up, or the order of the questions maybe reversed for even the same examinee. In any case, the image processing apparatus 10 of the present exemplary embodiment reads screen information of each answer sheet in stacking order of the plurality of bundled answer sheets, and sends the read screen information to the image information obtaining unit 41.

The text recognizing unit 42 obtains the image information from the image information obtaining unit 41. The text recognizing unit 42 performs text recognition of texts or numerals included in the obtained image information by using an optical character recognition (OCR) technology. In the following description, information of the texts or numerals recognized by the text recognizing unit 42 from the image information is referred to as recognition information.

The text recognizing unit 42 obtains the format information of the answer sheet as a text recognition target from the format information managing unit 43. The text recognizing unit 42 performs the text recognition for each entry field included in the format information. The text recognizing unit 42 associates the recognition information of each entry field with the classification of the corresponding entry field, and sends the recognition information to the list information generating unit 44.

For example, in a case where the text recognition is performed for the first answer entry field 106 of the answer sheet P1 of the first page shown in FIG. 2A, the text recognizing unit 42 performs text recognition of a portion designated by the format information as the first answer entry field 106 on the answer sheet Pl. The text recognizing unit 42 associates the classification of “first answer” corresponding to the first answer entry field 106 with the recognition information (for example, “ . . . aaa”).

For example, in a case where the text recognition is performed for the first question point entry field 108 of the answer sheet P1 of the first page, the text recognizing unit 42 performs text recognition of a portion designated by the format information as the first question point entry field 108 on the answer sheet P1. The text recognizing unit 42 associates the classification of “first question point” corresponding to the first question point entry field 108 with the recognition information (for example, “30”).

Similarly, the text recognizing unit 42 associates the corresponding classification with the recognition information recognized from the image information of the portion of each entry field designated by the format information. The text recognizing unit 42 sends a reading result obtained by associating the recognition information with the classification for each page of the answer sheet to the list information generating unit 44. In the present exemplary embodiment, each page of the answer sheet corresponds to one answer sheet as described above.

The format information managing unit 43 receives the creation of the format information of the answer sheet via the examiner terminal 30. For example, in a case where the answer sheets shown in FIGS. 2A and 2B are created, the format information managing unit 43 receives the designation of the position as the text recognition target on the answer sheet and the registration of the classification of the entry field as the text recognition target.

The format information managing unit 43 creates identification information 100 including the format information based on the received designation of the position and registration of the classification. The created identification information 100 is included in a print image of the answer sheet as a creating target (see FIGS. 2A and 2B).

The format information managing unit 43 manages a plurality of format information items for each already created answer sheet.

In a case where the text recognition for the image information of one answer sheet is performed by the text recognizing unit 42, the format information managing unit 43 specifies the format information from the identification information 100 included in the image information. The format information managing unit 43 sends the specified format information to the text recognizing unit 42 according to a request from the text recognizing unit 42.

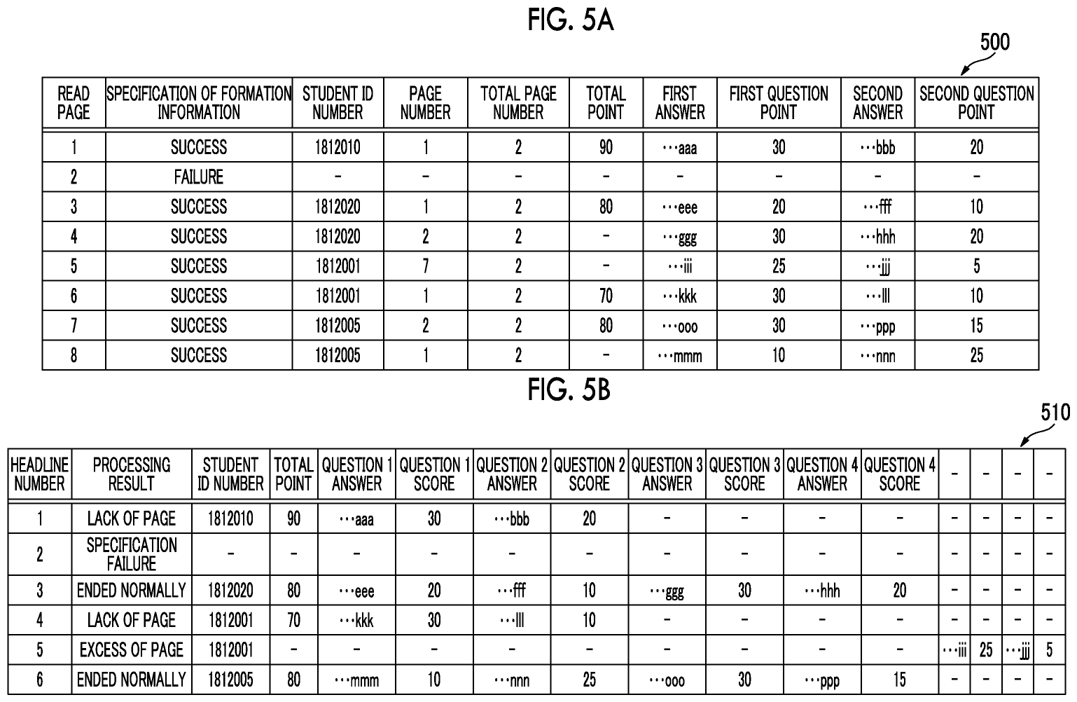

The list information generating unit 44 obtains the reading result obtained by associating the recognition information arranged for each page with the classification from the text recognizing unit 42. The list information generating unit 44 creates a score list 510 (see FIG. 5B to be described below) in which the recognition information items are arranged for each examinee based on the reading result obtained from the text recognizing unit 42. The plurality of question points is displayed in the order of the questions for each examinee in the score list 510 of the present exemplary embodiment.

Initially, the list information generating unit 44 uses the information of the student ID number in the present exemplary embodiment in order to specify the examinee who answers the answer sheet of the read image information. The student number is specified based on the recognition information of the number entry field 102. The list information generating unit 44 arranges the plurality of question points in the specified order based on the page information and the number of question points read from the answer sheets of the plurality of pages corresponding to the same student ID number. That is, the list information generating unit 44 creates the list on which the plurality of question points read from the answer sheets of the plurality of pages is arranged according to the page information.

Specifically, the list information generating unit 44 arranges the recognition information items of the plurality of question points according to the page order. Ina case where the plurality of question points is prepared within the same page, the list information generating unit 44 arranges the recognition information items of the plurality of question points within the same page in a predetermined order. In the present exemplary embodiment, as the predetermined order, the first question point comes first, and the second question point comes after.

For example, the list information generating unit 44 arranges the plurality of question points in the order of the plurality of question points (the first question point and the second question point) read from the answer sheet P1 of the first page and the plurality of question points (the first question point and the second question point) read from the answer sheet P2 of the second page, that is, in the order of the first question point and the second question point in the same page.

In the score list 510 of the exemplary embodiment, in a case where the plurality of answers is displayed in the order of the questions for each examinee, the aforementioned arrangement of the question points is also performed.

The list information generating unit 44 creates the item corresponding to each entry field in a case where the score list is created. The list information generating unit 44 of the present exemplary embodiment uses, as the item, the classification of each entry field specified by the format information. Here, the items created according to the order specified by the page information are used for the answer entry field and the question point entry field without using each classification with no change.

The list information generating unit 44 of the present exemplary embodiment uses, as the items, “total point” which is the classification of the total point entry field 101, “student ID number” which is the classification of the number entry field 102, and “page number” and “total page number” which are the classifications of the page information entry field 110.

The list information generating unit 44 of the present exemplary embodiment uses the items assigned “question number” based on and according to the page information for the answer entry field and the question point entry field. Here, in a case where items of an answer input field and a question point input field are displayed as “question N answer” and “question N score”, the question number is numerals corresponding to N (N is an integer).

The list information generating unit 44 assigns “question number” to each question point according to the specified order of the plurality of answers or question points as described above. The list information generating unit 44 of the present exemplary embodiment assigns the number of “1” in ascending order of page numbers, that is, in a predetermined question order in the same page.

For example, as the items of the question point entry field, the list information generating unit 44 creates an item of “question 1 score” for the first question point read from the answer sheet P1 of the first page, an item of “question 2 score” for the second question point read from the answer sheet P1 of the first page, an item of “question 3 score” for the first question point read from the answer sheet P2 of the second page, and an item of “question 4 score” for the second question point read from the answer sheet P2 of the second page.

Similarly, as the items of the answer entry field, the list information generating unit 44 creates items of “question 1 answer”, “question 2 answer”, “question 3 answer”, and “question 4 answer”.

In the present exemplary embodiment, the items of the answer entry field and the question point entry field based on the question number set by the list information generating unit 44 consequently correspond to “question 1”, “question 2”, “question 3”, and “question 4” printed as the entry field names on the answer sheet in advance.

In a case where an abnormality occurs in reading the plurality of answer sheets, the list information generating unit 44 performs abnormality processing. In this case, for example, an event in which the format information is not able to be specified and the reading location of the entry field and the classification of the entry field are consequently not able to be specified for the image information may be illustrated as an abnormality event. For example, a case where the reading of the identification information 100 succeeds but the page number of the page information is erroneously read or a case where partial reading fails may be illustrated as the abnormality event.

The list information generating unit 44 performs “abnormality display processing” and “classification display processing”, as the abnormality processing performed in a case where the abnormality occurs.

Initially, “abnormality display processing” will be described. The abnormality display processing is performed based on the occurrence of the event of “failure of specification of format information”, “excess of page” and “lack of page” in which the page number does not match the total page number.

Failure of Specification of Format Information

The list information generating unit 44 associates information for displaying an indication that the specification of the format information fails with the page on which the specification of the format information fails. The list information generating unit 44 displays text information of “specification failure” for the page on which the specification of the format information fails in a score list 510 to be described below (see FIG. 5B to be described below).

As a specific example in a case where the specification of the format information fails, the identification information 100 on the answer sheet may be contaminated, an irrelevant blank sheet maybe included in the bundle of answer sheets, or front and back sides of the answer sheet may be wrong.

Excess of Page

In a case where it is determined that the page is excessive, the list information generating unit 44 associates information for displaying an indication that the page is excessive with a target page. The list information generating unit 44 displays the text information of “excess of page” for the excessive page in a score list 510 to be described below.

In this case, the determination that the page is excessive is performed based on the information of the total page number and the page number obtained by performing the text recognition for the page information entry field 110. In a case where the total page number is recognized as, for example, X pages, the list information generating unit 44 determines that the page is excessive in a case where a numeral which is greater than X is recognized as the page number indicating the number of pages.

Lack of Page

In a case where it is determined that the page lacks, the list information generating unit 44 associates information for displaying an indication that the page lacks with the test of the examinee as a target. The list information generating unit 44 displays text information of “lack of page” for the test of the examinee in which the page lacks in a score list 510 to be described below.

In this case, the determination that the page lacks is performed based on the information of the total page number obtained by performing the text recognition for the page information entry field 110. For example, in a case where the total page number is recognized as Y pages, the list information generating unit 44 determines that the page lacks in a case where the plurality of page numbers obtained by reading the answer sheet is less than the Y pages as the total page number.

In a case where all the answer sheets of the plurality of pages in one test of a certain examinee is normally read, the list information generating unit 44 displays information of an indication that the reading is normally ended on a score list 510 to be described below. The list information generating unit 44 of the present exemplary embodiment displays text information of “ended normally” for the test of the examinee in which the reading is normally ended in the score list 510.

Next, “classification display processing” will be described.

In a case where a plurality of answer sheets constituting one test in which one examinee answers is normally read, the list information generating unit 44 prepares a “row” in the score list 510 (see FIG. 5B to be described below), and displays a plurality of question points of one test of one examinee in one row. As described above, the list information generating unit 44 displays the plurality of question points in one row based on the page information.

In a case where the plurality of answer sheets constituting one test in which other examinees different from the one examinee answer is normally read, the list information generating unit 44 prepares other “rows” in the score list 510, and displays the plurality of question points of one test of other examinees in other rows. For example, the student ID numbers of the one examinee and other examinees are arranged in a column direction in the score list 510. Similarly, the question points of the one examinee and other examinees are arranged in the column direction for each question number. As stated above, the list information generating unit 44 displays the items of the same classification in the column direction in the score list 510.

Meanwhile, in a case where an abnormality occurs in reading the plurality of answer sheets constituting one test in which one examinee answers, the list information generating unit 44 displays information regarding the abnormality in a column or a row in the score list 510 different from a case where the reading is normally performed.

For example, the list information generating unit 44 prepares one row for the page on which the specification of the format information fails, and displays the text of “specification failure” in the one row.

In a case where it is determined that the page is excessive, the list information generating unit 44 prepares one row on the page determined to be excessive, and displays the text of “excess of page” in the one row. In a case where it is determined that the page is excessive, the list information generating unit 44 displays the question point recognized from the page determined to be excessive in a column different from the normally read question point.

In a case where it is determined that the page lacks, the list information generating unit 44 prepares one row for the page determined to lack, and displays the text of “lack of page” in the one row. In a case where it is determined that the page lacks, the list information generating unit 44 displays the question point recognized from the page determined to lack the question number of the normally read question point.

In a case where the list information generating unit 44 creates the score list 510, the score managing unit 45 obtains the score list 510 from the list information generating unit 44. The score managing unit 45 stores the score list 510 created by the list information generating unit 44. The score managing unit 45 manages a plurality of score lists 510 created in the past.

The score managing unit 45 also manages score information browsed by the examinee separately from the score list 510. Information browsed by the examinee is created based on the score list 510. For example, read data of the scored answer sheet for which the examinee answers or the score list in which the scoring results of only one examinee are arranged may be used as browsing information.

The display control unit 46 creates an image for displaying information regarding the utilization of the learning support terminal 40, and transmits the created image to each apparatus by using the image processing apparatus 10, the examinee terminal 20, and the examiner terminal 30 that access the learning support terminal 40.

In a case where the reading for the bundle of answer sheets is performed by the image processing apparatus 10, the display control unit 46 displays a command image related to a reading operation on a display screen of the image processing apparatus 10.

In a case where a browsing request for the score list 510 created by the score managing unit 45 is received from the examiner terminal 30, the display control unit 46 creates display information for displaying the score list 510 on the examiner terminal 30, and transmits the created display information to the examiner terminal 30. In a case where a download request for the score list 510 created by the score managing unit 45 is received from the examiner terminal 30, the display control unit 46 creates a file for downloading the score list 510, and transmits the created file to the examiner terminal 30.

In a case where a browsing request for the browsing information created by the score managing unit 45 is received from the examinee terminal 20, the display control unit 46 creates display information for displaying the browsing information to the examiner terminal 30, and transmits the created display information to the examinee terminal 20.

In the present exemplary embodiment, the display control unit 46 is an example of a transmission unit.

Next, an operation example for collecting the scoring result in the information processing system 1 of the present exemplary embodiment will be described.

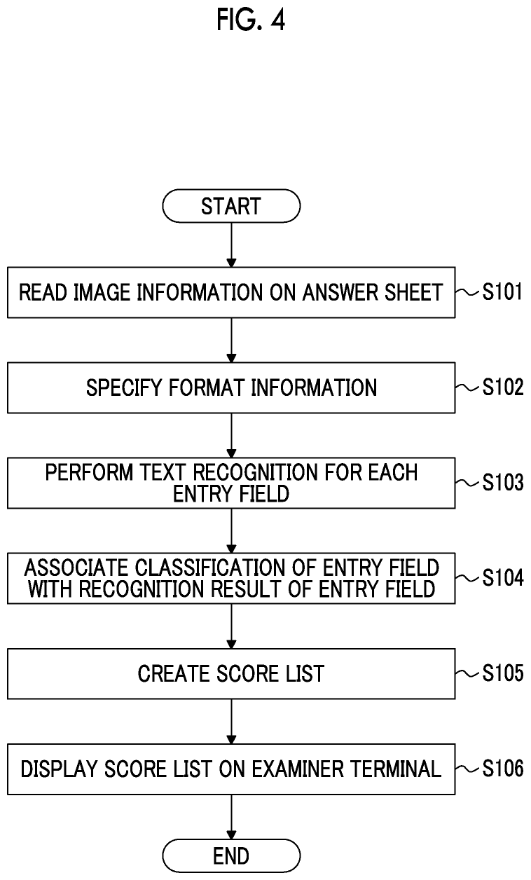

FIG. 4 is an operation flowchart for collecting the scoring result in the information processing system 1 of the present exemplary embodiment.

As shown in FIG. 4, the examiner sets a bundle of a plurality of scored answer sheets in the image processing apparatus 10. The image processing apparatus 10 reads the image information of the image on each answer sheet of the plurality of answer sheets (step S101).

The learning support terminal 40 obtains the image information obtained by reading each answer sheet from the image processing apparatus 10. The learning support terminal 40 reads the identification information 100 prepared on each answer sheet. The learning support terminal 40 specifies the format information of the answer sheet (step S102). The learning support terminal 40 performs the text recognition for each entry field on the image information based on the information of the position of the entry field indicated by the format information (step S103). The learning support terminal 40 performs the text recognition for the image information for each page of the answer sheets. The learning support terminal 40 associates the classification of each entry field with the recognition information of each entry field (step S104).

Step S101 to step S104 are performed for the plurality of answer sheets set in the image processing apparatus 10.

Thereafter, the learning support terminal 40 creates the score list 510 by using the recognition information associated with the classification (step S105). In this case, the learning support terminal 40 creates the score list 510 in which the scoring results are arranged for each examinee and the plurality of questions is arranged in the question order based on the page information.

The learning support terminal 40 displays the score list 510 generated by collecting the scoring result on the display screen of the examiner terminal 30 (step S106). The learning support terminal 40 downloads the score list 510 generated by collecting the scoring result to the examiner terminal 30 according to a request.

Next, the creation of the score list 510 performed by the information processing system 1 of the present exemplary embodiment will be described in detail.

FIGS. 5A and 5B are explanatory diagrams of the score list 510 created by the information processing system 1 of the present exemplary embodiment.

FIG. 5A is a reading result list 500 on which the plurality of recognition information items is arranged for each page (hereinafter, referred to as a read page) of the answer sheet read by the image processing apparatus 10. For example, the reading result list 500 shown in FIG. 5A is not browsed by the examiner, and is used by the learning support terminal 40 creating the score list 510. FIG. 5B is the score list 510 created from the reading result list 500 shown in FIG. 5A.

As shown in FIG. 5A, the reading result is obtained for each page by reading the bundle of answer sheets.

In this case, the reading result list shown in FIG. 5A includes an item of “specification of formation information” indicating the result of the success or failure of the specification of the format information.

The reading result list includes items of “student ID number” which is the recognition information of the number entry field 102, “page number” which is the recognition information of the page information entry field 110, and “total page number” which is the recognition information of the page information entry field 110. The reading result list includes items of “total point” which is the recognition information of the total point entry field 101, “first answer” which is the recognition information of the first answer entry field 106, “first question point” which is the recognition information of the first question point entry field 108, “second answer” which is the recognition information of the second answer entry field 107, and “second question point” which is the recognition information of the second question point entry field 109.

As shown in FIG. 5B, the score list 510 is created based on the reading result list.

In this case, an item of “headline number”, an item of “processing result” indicating a read processing result are prepared in the score list 510. Items of “student ID number”, “total point”, “question 1 answer”, “question 1 score”, “question 2 answer”, “question 2 score”, “question 3 answer”, “question 3 score”, “question 4 answer”, and “question 4 score” are prepared in the score list 510.

As shown in FIG. 5A, a read page 1 and a read page 2 are obtained by reading image information items of answer sheets of two pages for which an examinee having a student ID number of 1812010 answers. Here, in this example, the reading of the answer sheet P1 of the first page succeeds, but the reading of the answer sheet P2 of the second page fails.

The score list 510 created based on the read page 1 and the read page 2 shown in FIG. 5A is displayed as a headline number 1 and a headline number 2 of FIG. 5B. The learning support terminal 40 recognizes that the total page number is two pages based on the page information of the recognition information of the read page 1. However, only the read page having the page number of the first page is present for the same student ID number obtained from the bundle of currently read answer sheets. From these results, the learning support terminal 40 determines that the page lacks for the read page 1.

The recognition information items of the first answer and the second answer on the first page and the recognition information items of the first question point and the second question point on the first page are obtained from the read page 1.

As stated above, in a row of the headline number 1 of the score list 510, “lack of page” is displayed in the item of “processing result”, and the recognition information items are displayed in the items of “student ID number”, “total point”, “question 1 answer”, “question 1 score”, “question 2 answer”, and “question 2 score”. However, in the row of the headline number 1 of the score list 510, the items of “question 3 answer”, “question 3 score”, “question 4 answer”, and “question 4 score” are empty fields.

In a row of the headline number 2 of the score list 510, “specification failure” is displayed in the item of the processing result.

As shown in FIG. 5A, a read page 3 and a read page 4 are obtained by reading image information items of answer sheets of two pages for which an examinee having a student ID number of 1812020 answers. In this example, the reading of both the answer sheet P1 of the first page and the answer sheet P2 of the second page succeeds.

The score list 510 created based on the read page 3 and the read page 4 shown in FIG. 5A is displayed in a row of the headline number 3 of FIG. 5B. The learning support terminal 40 specifies that the total page number is two pages based on the page information of the recognition information of the read page 1. The learning support terminal 40 recognizes the presence of the page numbers of the first page and the second page for the same student ID number. Accordingly, the learning support terminal 40 determines that the read page 3 and the read page 4 are normally read.

The first answer and the second answer on the first page and the first question point and the second question point on the first page are obtained as the recognition information items from the read page 3. Similarly, the first answer and the second answer on the second page and the first question point and the second question point on the second page are obtained as the recognition information items from the read page 4.

As stated above, in the row of the headline number 3 of the score list 510, “ended normally” is displayed in the item of “processing result”, and the recognition information items are displayed in the items of “student ID number”, “total point”, “question 1 answer”, “question 1 score”, “question 2 answer”, “question 2 score”, “question 3 answer”, “question 3 score”, “question 4 answer”, and “question 4 score”.

As shown in FIG. 5A, a read page 5 and a read page 6 are obtained by reading image information items of answer sheets of two pages for which an examinee having a student ID number of 1812001 answers. In this example, the reading of both the answer sheet P1 and of the first page and the answer sheet P2 of the second page succeeds. Here, the page number of the answer sheet P2 of the second page is erroneously recognized. That is, the page number of the answer sheet P2 of the second page is supposed to be originally recognized as “2”, but is erroneously recognized as “7”.

The score list 510 created based on the read page 5 and the read page 6 shown in FIG. 5A is displayed as a headline number 4 and a headline number 5 of FIG. 5B.

Initially, the learning support terminal 40 recognizes that the total page number is 2 pages based on the page information of the recognition information of the read page 5. However, a read page having a page number of a seventh page is actually present. From this result, the learning support terminal 40 determines that the page is excessive for the read page 5.

The first answer and the second answer of the seventh page and the first question point and the second question point of the seventh page are obtained as the recognition information items from the read page 5.

The learning support terminal 40 specifies that the total page number is two pages based on the page information of the recognition information of the read page 6. However, only the read page having the page number of the second page is present for the same student ID number obtained from the bundle of currently set answer sheets. From this result, the learning support terminal 40 determines that the page lacks for the read page 6.

The first answer and the second answer of the first page and the first question point and the second question point of the first page are obtained as the recognition information items from the read page 6.

As stated above, in a row of the headline number 4 of the score list 510, “lack of page” is displayed in the item of “processing result”, and the recognition information items are displayed in the items of “student ID number”, “total point”, “question 1 answer”, “question 1 score”, “question 2 answer”, and “question 2 score” for the read page 6. However, in the row of the headline number 4 of the score list 510, the items of “question 3 answer”, “question 3 score”, “question 4 answer” and “question 4 score” are empty fields.

In a row of the headline number 5 of the score list 510, “excess of page” is displayed in the item of “processing result”, and the recognition information of “student ID number” is displayed for the read page 5. The items of “total point”, “question 1 answer”, “question 1 score”, “question 2 answer”, “question 2 score”, “question 3 answer”, “question 3 score”, “question 4 answer”, and “question 4 score” are empty fields. In the row of the headline number 5 of the score list 510, the first answer and the second answer of the seventh page, and the recognition information items of the first question point and the second question point of the seventh page are displayed in items different from the items of the questions or the items of the answers normally read. In the present exemplary embodiment, these recognition information items are displayed without being assigned the item names.

As shown in FIG. 5A, a read page 7 and a read page 8 are obtained by reading image information items of answer sheets of two pages for which an examinee having a student ID number of 1812005 answers. In this example, the reading of both the answer sheet P1 of the first page and the answer sheet P2 of the second page succeeds. Here, in this example, the order of the answer sheets of two pages of the bundle of answer sheets set in the image processing apparatus 10 for which the examinee having the student ID number of 1812005 answers is reversed in reading the answer sheets.

The score list 510 created based on the read page 7 and the read page 8 shown in FIG. 5A is displayed in a row of a headline number 6 of FIG. 5B. The learning support terminal 40 specifies that the total page number is two pages based on the page information of the recognition information of the read page 1. The learning support terminal 40 recognizes the presence of the page numbers of the first page and the second page for the same student ID number. Accordingly, the learning support terminal 40 determines that the read page 7 and the read page 8 are normally read.

The first answer and the second answer of the second page and the first question point and the second question point of the second page are obtained as the recognition information items from the read page 7. Similarly, the first answer and the second answer of the first page and the first question point and the second question point of the first page are obtained as the recognition information items from the read page 8.

In the row of the headline number 6 of the score list 510, “ended normally” is displayed in the item of “processing result”, and the recognition information items are displayed in the items of “student ID number”, “total point”, “question 1 answer”, “question 1 score”, “question 2 answer”, “question 2 score”, “question 3 answer”, “question 3 score”, “question 4 answer”, and “question 4 score”. Particularly, although the order of the answer sheets of the examinee having the same student ID number is reversed at the time of reading in the image processing apparatus 10 in this example, the answers and the question numbers of the question points are arranged according to the question order in the score list 510.

Next, an information processing system 1 of Modification Example 1 will be described.

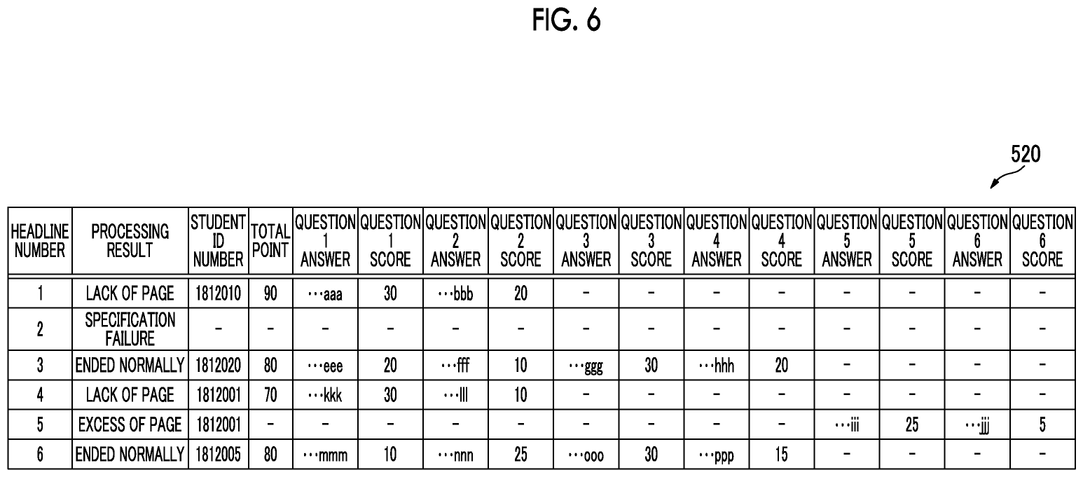

FIG. 6 is an explanatory diagram of a score list 520 to which Modification Example 1 is applied.

The score list 520 of Modification Example 1 is created from the reading result list shown in FIG. 5A. In the score list 520 of Modification Example 1, the question numbers assigned to the items of the recognition information items of the answer entry field and the question point entry field of the read page 5 determined to be excessive are different from those of the aforementioned exemplary embodiment.

In the score list 520 of Modification Example 1 shown in FIG. 6, the display related to the normally ended read page and the read page determined to lack is similar to the score list 510 shown in FIG. 5B.

Here, in the score list 520 of Modification Example 1, the question numbers of the page determined to be excessive are assigned so as to be different from the question numbers assigned to the page determined to be normal. In this example, in the row of the headline number 5, the item names of “question 5 answer” and “question 5 score” are assigned to “first answer” and “first question point” read from the read page 5 (see FIG. 5A) determined to be excessive. The item names of “question 6 answer” and “question 6 score” are assigned to “second answer” and “second question point” read from the page 5 determined to be excessive.

Next, an information processing system 1 of Modification Example 2 will be described.

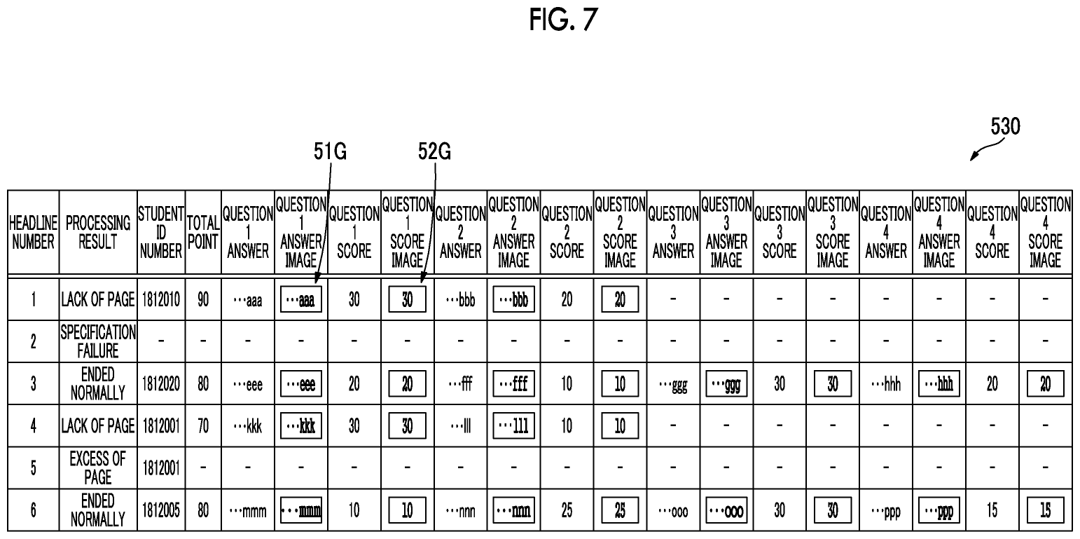

FIG. 7 is an explanatory diagram of a score list 530 to which Modification Example 2 is applied.

The score list 530 of Modification Example 2 is created from the reading result list shown in FIG. 5A. As shown in FIG. 7, in the score list 530 of Modification Example 2, a partial image of the answer entry field on the answer sheet is displayed so as to be adjacent to the corresponding answer entry field. For example, in the score list 530 of Modification Example 2, in the row of the headline number 1, an image 51G of the answer entry field as a source of the recognition information of “ . . . aaa” which is the question 1 answer is arranged in a column adjacent to the recognition information of the answer entry field. The image 51G is an image obtained by cutting a portion of the answer entry field from the image information obtained by reading the answer sheet. The image 51G of the answer entry field is displayed in the item of “question N answer image” (N is an integer).

In the score list 530 of Modification Example 2, an image of a portion of the question point entry field on the answer sheet is displayed so as to be adjacent to the corresponding question point entry field. For example, in the score list 530 of Modification Example 2, in the row of the headline number 1, an image 52G of the question point entry field as a source of the recognition information of “30” which is the question 1 score in a column adjacent to the recognition information of the question point entry field. The image 52G is an image obtained by cutting the portion of the question point entry field from the image information obtained by reading the answer sheet. The image 52G of the question point entry field is displayed in the item of “question N score image” (N is an integer).

Next, an information processing system 1 to which Modification Example 3 is applied will be described.

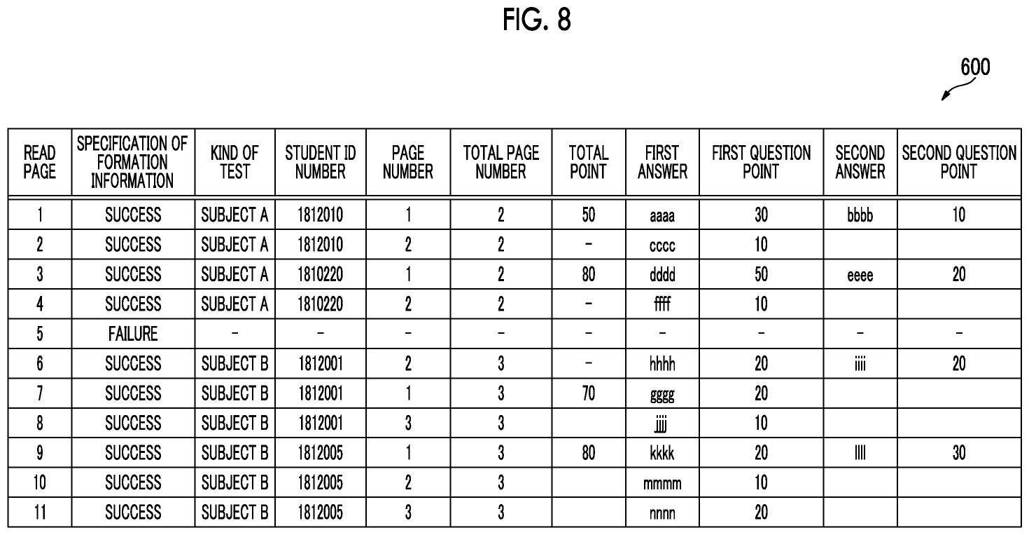

FIG. 8 is an explanatory diagram of a reading result list 600 of Modification Example 3.

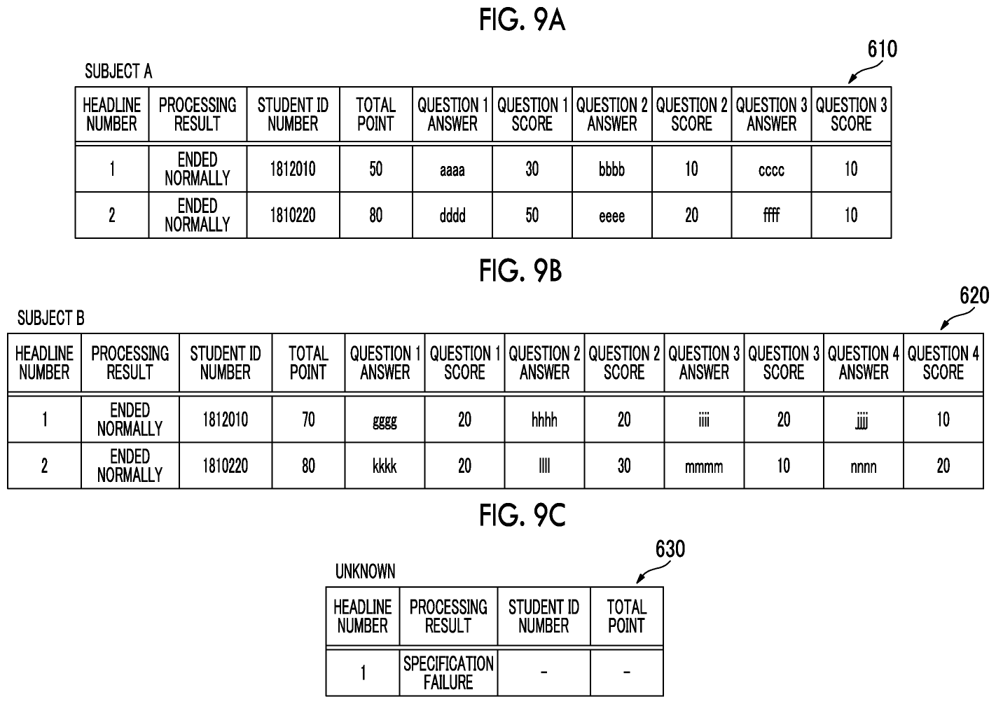

FIGS. 9A, 9B, and 9C are score lists (a score list 610, a score list 620, and a score list 630) of Modification Example 3 created from the reading result list 600 shown in FIG. 8.

As shown in FIG. 8, the reading result is obtained for each read page by reading the bundle of answer sheets. Here, answer sheets of two kinds of tests of an answer sheet of a test of subject A and an answer sheet of a test of subject B are present in the bundle of answer sheets of Modification Example 3.

The reading result list shown in FIG. 8 includes “subject” which is the recognition information of the subject entry field 105 in addition to the recognition information items of “specification of format information”, “student ID number”, “page number”, “total page number”, “total point”, “first answer”, “first question point”, “second answer”, and “second question point”. In the example shown in FIG. 8, two kinds of subjects of subject A and subject B are recognized as the subjects.

In Modification Example 3, the score list in which the scoring results are arranged for each subject is created. In Modification Example 3, the score list 610 in which the scoring results are arranged for subject A is created for the test of subject A, as shown in FIG. 9A. A title of the score list 610 in which the scoring results of subject A are arranged is displayed as “subject A”.

The score list 620 in which the scoring results are arranged for subject B is created for the test of subject B, as shown in FIG. 9B. A title of the score list 620 in which the scoring results of subject B are arranged is displayed as “subject B”.

In Modification Example 3, the score list 630 in which the page for which the specification of the format information fails is arranged is created, as shown in FIG. 9C. A title of the score list 630 in which the page for which the specification of the format information fails is arranged is displayed as “unknown”.

Hardware Configuration of Each Apparatus

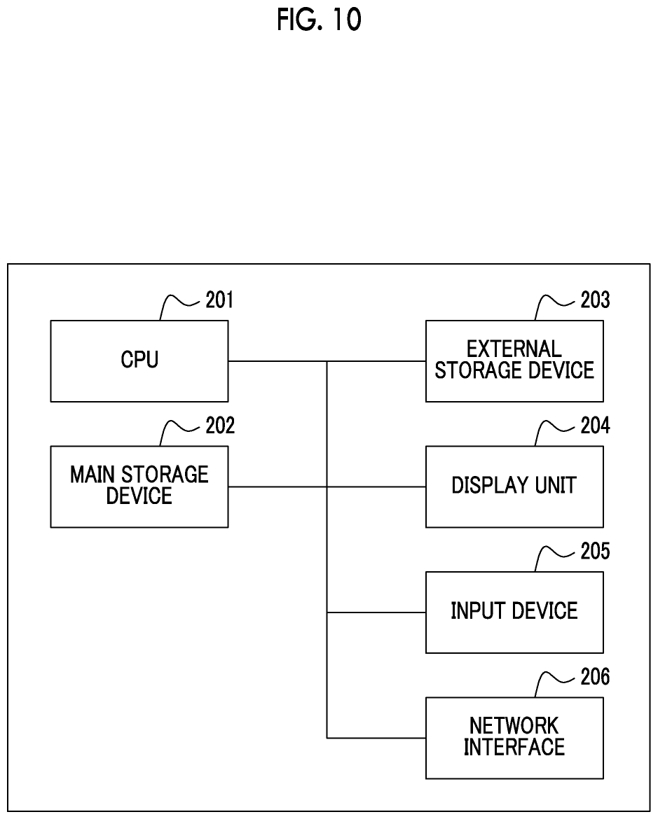

FIG. 10 is a diagram showing a hardware configuration example of a computer that realizes the image processing apparatus 10, the examinee terminal 20, the examiner terminal 30, and the learning support terminal 40.

The computer shown in FIG. 10 includes a central processing unit (CPU) 201 which is arithmetic means, a main storage device (main memory) 202 which is storage means, and an external storage device 203. The CPU 201 reads a program stored in the external storage device 203 into the main storage device 202, and executes the program. For example, a random access memory (RAM) is used as the main storage device 202. For example, a magnetic disk device or a solid state drive (SSD) is used as the external storage device 203. For example, the computer includes a display unit (display) 204 that display an image, and an input device 205 such as a keyboard or a mouse used by an operator of the computer performing an input operation. The computer includes a network interface 206 for connecting the computer to the network 50.

A configuration of the computer shown in FIG. 10 is merely an example, and is not limited to the configuration example of FIG. 10. For example, the storage device may include a nonvolatile memory such as a flash memory or a read only memory (ROM).

A specific configuration may be different depending on an application target such as the image processing apparatus 10, the examinee terminal 20, the examiner terminal 30, and the learning support terminal 40. For example, the image processing apparatus 10, the examinee terminal 20, the examiner terminal 30, and the learning support terminal 40 may be a single apparatus of the computer, or may be realized by distribution processing using a plurality of computers.

All the functions of the learning support terminal 40 are not limited to be realized by the learning support terminal 40. For example, the functions of the learning support terminal 40 may be realized by a part or all of the image processing apparatus 10, the examinee terminal 20, and the examiner terminal 30.

The program that realizes a series of operations of the information processing system 1 of the present exemplary embodiment by the image processing apparatus 10, the examinee terminal 20, the examiner terminal 30, and the learning support terminal 40 is provided by, for example, communication means, and may be provided while being stored in various recording media.

The relationship between the row and the column of each score list of the present exemplary embodiment is not limited to the aforementioned example. For example, although the recognition information items of the entry fields for each examinee are arranged in the row direction in the score list in the present exemplary embodiment, the recognition information items of the entry fields for each examinee may be arranged in the column direction.

While the exemplary embodiment of the present invention has been described, the technical scope of the present invention is not limited to the exemplary embodiment. Various modifications and alternative configurations without departing from the scope of the technical idea of the present invention are included in the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
an obtainment unit that obtains image information of an image on each document from a plurality of documents each of which has page information regarding a page order of the plurality of documents and on which questions answered by an examinee are scored;
a specification unit that specifies at least examinee information regarding the examinee, question point information regarding a question point which is a score of each question, and the page information from the obtained image information; and
a creation unit that creates a list in which a plurality of the question points is arranged based on the page information for each examinee.

2. The information processing system according to claim 1,
wherein the creation unit creates the list in which abnormality information regarding an abnormality specified based on the page information is displayed.

3. The information processing system according to claim 2,
wherein the creation unit creates the list in which the abnormality information is displayed in a row or a column different from normally specified information.

4. The information processing system according to claim 2,
wherein the creation unit creates the list in which the abnormality information is displayed in a case where a page number specified from the document does not match a total page number of the document for which one examinee answers.

5. The information processing system according to claim 2,
wherein the creation unit creates the list in which display of an indication of being normal is assigned to normally specified information.

6. The information processing system according to claim 1,
wherein the creation unit creates the list in which a question number corresponding to the page information of each document is assigned to a plurality of the question points.

7. The information processing system according to claim 6,
wherein, in a case where an abnormality based on the page information is specified, the creation unit creates the list in which the question point is displayed without assigning the question number to the question point related to the abnormality.

8. The information processing system according to claim 1,
wherein the specification unit specifies text information obtained by performing character recognition on an answer filled by the examinee from the image information, and
the creation unit creates the list in which an image of the answer and the text information are arranged for each question.

9. The information processing system according to claim 1,
wherein the specification unit specifies a kind of the document related to the question, and
the creation unit creates the list including kind information regarding the kind of the document.

10. An information processing apparatus comprising:
an obtainment unit that obtains image information of an image on each document from a plurality of documents each of which has page information regarding a page order of the plurality of documents and on which questions answered by an examinee are scored;
a specification unit that specifies at least examinee information regarding the examinee, question point information regarding a question point which is a score of each question, and the page information from the obtained image information; and
a transmission unit that transmits information for creating a list in which a plurality of the question points is arranged based on the page information for each examinee.

11. A non-transitory computer readable medium storing a program causing a computer that functions as an information processing apparatus to realize:
a function of obtaining image information of an image on each document from a plurality of documents each of which has page information regarding a page order of the plurality of documents and on which questions answered by an examinee are scored;
a function of specifying at least examinee information regarding the examinee, question point information regarding a question point which is a score of each question, and the page information from the obtained image information; and
a function of transmitting information for creating a list in which a plurality of the question points is arranged based on the page information for each examinee.
